(19) United States
(12) Patent Application Publication
(10) Pub. No.: US 2026/0187628 A1
(43) Pub. Date: Jul. 2, 2026

(54) SYSTEMS AND METHODS FOR AUTOMATED TELLER MACHINE PROVISIONED PASSKEY ENROLLMENT

(71) Applicant: Wells Fargo Bank, N.A., San Francisco, CA (US)

(72) Inventors: Kimberly R. Nelson, Mooresville, NC (US); Matthew N. Wheeler, Charlotte, NC (US); John Andrew Chuprevich, Davidson, NC (US)

(21) Appl. No.: 19/008,283

(22) Filed: Jan. 2, 2025

(51) Int. Cl. G06Q 20/38; G06Q 20/10; G06Q 20/32; G06Q 20/40; G06V 10/74; G06V 40/16

(52) U.S. Cl. CPC G06Q 20/3829; G06Q 20/1085; G06Q 20/3278; G06Q 20/40145; G06V 10/761; G06V 40/172

(57) ABSTRACT

Systems, apparatuses, methods, and computer program products are disclosed for automated teller machine (ATM) provisioned passkey enrollment. An example method includes receiving, from an ATM, a first ATM access request associated with a user and determining, based on a user identifier, a first user authentication result. The example method further includes receiving, from the ATM, a passkey enrollment request in response to a successful first user authentication result and determining, based on the passkey enrollment request, a passkey enrollment result. The example method further includes transmitting permissioned passkey enrollment instructions to the proximate user device in response to a successful passkey enrollment result and receiving, from the proximate user device, a public key. The example further includes storing the public key and device identifier in a user profile associated with the user.

### BACKGROUND

Automated Teller Machines (ATMs) are frequently located in public locations for user convenience and accessibility. However, since ATMs are accessible to a variety of users, they are exposed to a range of security vulnerabilities.

### BRIEF SUMMARY

Automated Teller Machines (ATMs) provide an accessible resource that individuals may utilize to perform various banking actions (e.g., withdrawals, deposits, transfers of funds, account balance checks, and/or the like) without the need for the individual to directly interact with banking staff (e.g., speaking with a bank teller in a brick-and-mortar location, on a phone call, or the like). As such, ATMs are now ubiquitous in society, and therefore it is common for entities (e.g., financial institutions) to utilize ATMs and for individuals to interact with ATMs to perform banking actions. However, the widespread use of ATMs in public settings (e.g., parks, shopping malls, airports, or the like) comes with an inherent increase in exposure to bad actors. For example, since ATMs are frequently in public locations, bad actors may have access to the ATM and thus may tamper with the ATM to obtain sensitive data by e.g., using a skimming device to obtain personal identifiable information (PII) associated with users who interact with the ATM, exploiting weak authentication factors (e.g., using an illegally obtained password to gain access to a user's account), or the like. Moreover, since many individuals may interact with an ATM, a security vulnerability that is exploited by a bad actor may result in the bad actor obtaining sensitive data about a plurality of users. In this regard, thoughtful security techniques are required to ensure the security of user and entity related data (e.g., PII, account data, or the like) by reducing the likelihood of unauthorized ATM access and/or fraud.

Traditionally, ATMs implement various security techniques to safeguard user and/or entity data that may be accessible via an ATM. For example, an ATM may use personal identification numbers (PINs) to authenticate users, such that a purported user may not be granted access to PII and/or user account data unless a user input PIN is successfully verified. In another example, ATMs may be equipped with tamper resistant casings that prevent unauthorized access to internal components of an ATM, such as the cash dispenser, a card reader, or the like. In this regard, if physical access of a tamper resistant casing is achieved, the ATM may be configured to prevent unauthorized access to user account data by self-disabling, alerting the entity to which the ATM corresponds, and/or the like.

While the above-described security techniques attempt to prevent and/or deter bad actors, advancements in hacking and fraud techniques leave ATMs and the data that ATMs protect (e.g., user account data) vulnerable. For example, despite anti-skimming technologies that detect the presence of traditional skimming devices, bad actors may rely upon advanced skimming techniques, such as shimming, where a thin device is inserted into the card reader of an ATM to intercept and obtain chip-based card data. In another example, bad actors may utilize PIN interception techniques, such as shoulder surfing, hidden cameras, keypad overlays, or the like, to obtain a user's pin that may then be utilized (and in some cases in combination with other stolen data) to access user account data (e.g., financial data) and perform account specific actions (e.g., withdrawals, fund transfers, or the like) via an ATM. In yet another example, ATMs may be vulnerable to a malware-based attack that exploits vulnerabilities in the ATMs software. In particular, a bad actor may deploy malware that takes over the operation of an ATM, and thus allows the bad actor to steal sensitive data (e.g., PII) without the need of a physical card (e.g., a debit card).

The inherent blind spots and shortcomings associated with traditional ATM security techniques presents a technical problem. As such, a need exists for a solution that securely establishes an authentication method that is not susceptible to the above-described fraud techniques (e.g., card-based, PIN-based, Malware-based fraud techniques). Example embodiments provide a technical solution to this technical problem because example embodiments do not require manual intervention. Additionally, by leveraging (i) a variety of authentication factors to securely authenticate a user and (ii) an indication of a proximate computing device (e.g., a computing device within a detectable proximity range of an ATM), example embodiments may securely provision a passkey to a legitimate computing device associated with a user (e.g., the proximate computing device). As such, since example embodiments provide secure passkey enrollment, example embodiments may further leverage the enrolled passkey to further provide a technical solution that utilizes a cryptographically secure and passwordless authentication method (e.g., passkeys). For example, the use of passkeys for ATM user authentication significantly mitigates the above-described fraud-based vulnerabilities associated with traditional ATM authentication techniques (e.g., PIN authentication factors, passwords, card numbers, or the like) by removing a dependency on a physical shared authentication factor. More particularly, since passkeys do not require the use of a physical card for authentication, bad actors cannot capture card data via traditionally skimming devices, shoulder surfing, or the like. Moreover, passkeys leverage public-key cryptography where a private key is securely stored (e.g., in a secure enclave) on a computing device associated with a user, and thus is not accessible for interception by a bad actor via a malware-based ATM attack or during an ATM action (e.g., a transaction, authentication, or the like).

Example embodiments described herein mitigate the above concerns by creating and using a centralized system that leverages an ATM to enroll device-bound passkeys for subsequent user ATM authentication. To do so, example embodiments may receive a first ATM access request associated with a user. The first ATM access request may be an electronic request that is transmitted from an ATM in response to a user attempting to access the ATM. In some embodiments, the ATM access request may include an indication of the ATM that transmitted the first ATM access request and/or a user identifier that uniquely identifies the user that is attempting to access the ATM. The user identifier may be, but is not limited to a card number, a personal identification number (PIN), a one-time password (OTP), a quick response (QR) code, or the like. Example embodiments may then determine a first user authentication result. The first user authentication result may include an indication of whether the user associated with the first ATM access request is successfully authenticated based on the first ATM access request.

In response to determining a successful first user authentication result, example embodiments may receive, from the ATM, a passkey enrollment request. The passkey enrollment request may be an electronic request that comprises an indicator of a proximate user device (e.g., a user device proximate to the ATM) and a user authentication factor associated with the user (e.g., a biometric, a photo of the user, or the like). Example embodiments may then determine, based on the passkey enrollment request, a passkey enrollment result. The passkey enrollment result may indicate whether the system authorizes the proximate user device to generate a passkey.

In response to a successful passkey enrollment result, example embodiments may transmit permissioned passkey enrollment instructions to the proximate user device. The permissioned passkey enrollment instructions may be included in an electronic request that instructs the proximate user device to generate a private-public key pair. Example embodiments may then receive a public key from the proximate user device. Example embodiments may then store the public key and the device identifier in a user profile associated with the user. The user profile may be a data structure that comprises user account data (e.g., baseline authentication factors, user demographic data, or the like).

Additionally, example embodiments described herein allow for an enhanced ATM authentication method by using an enrolled passkey to securely authenticate a user. In particular, in some embodiments, passkey authentication challenge may be generated and subsequently transmitted to a computing device associated with a user that requested to access an ATM. The ATM may then receive a completed passkey authentication challenge (e.g., an authentication challenge that is signed with a private key on the computing device associated with the user requesting access to an ATM) and utilize a public key associated with the user, which was obtained during passkey enrollment, to authenticate a user. As such, the private key that signed the passkey authentication challenge is not shared during the user authentication process, and thus allows for an enhanced authentication procedure that is not vulnerable to traditional ATM fraud techniques (e.g., shoulder surfing, skimming devices, or the like).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for ATM provisioned passkey enrollment, in accordance with some example embodiments described herein.

FIG. 4 illustrates an example flowchart for verifying a mobile driver's license (mDL), in accordance with some example embodiments described herein.

FIG. 5 illustrates an example flowchart for determining a metadata security score for a passkey enrollment request, in accordance with some example embodiments described herein.

FIG. 6 illustrates another example flowchart for verifying an image of the user, in accordance with some example embodiments described herein.

FIG. 7 illustrates an example flowchart for enhanced ATM authentication, in accordance with some example embodiments described herein.

FIG. 8 illustrates an example flowchart for using a user access parameter set to determine a passkey authentication result, in accordance with some example embodiments described herein.

FIG. 9 illustrates an example flowchart for verifying an image of the user, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

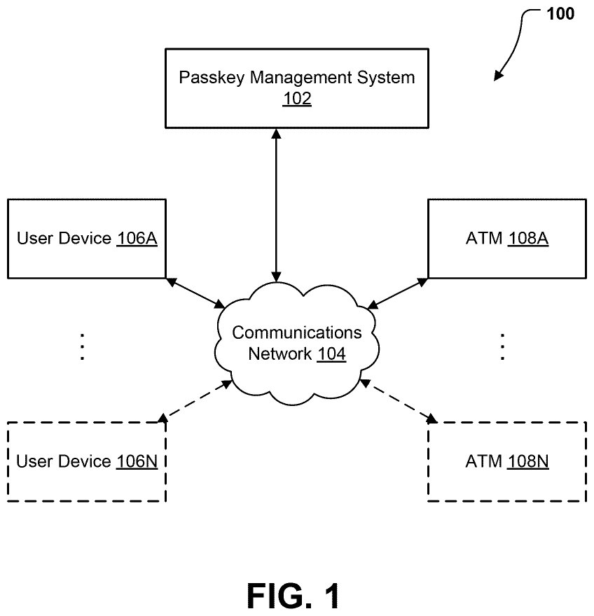

Example embodiments described herein may be implemented using any of a variety of computing devices or servers. To this end, FIG. 1 illustrates an example environment 100 within which various embodiments may operate. As illustrated, a passkey management system 102 may receive and/or transmit information via communications network 104 (e.g., the Internet) with any number of other devices, such as one or more of user devices 106A-106N and/or ATMs 108A-108N.

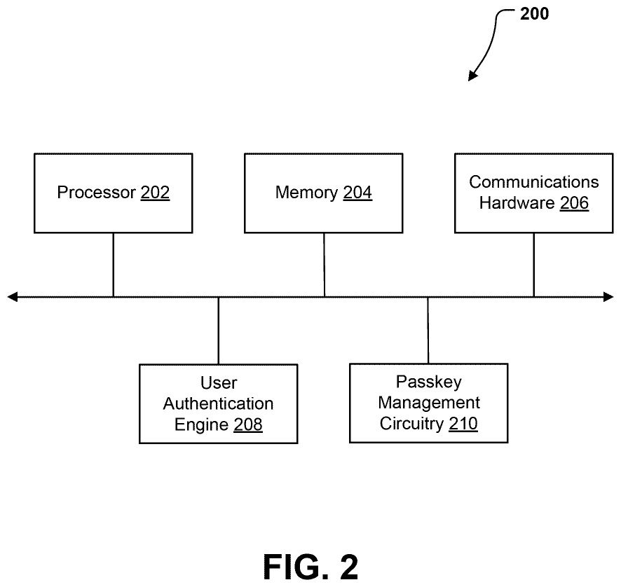

The passkey management system 102 may be implemented as one or more computing devices or servers, which may be composed of a series of components. Particular components of the passkey management system 102 are described in greater detail below with reference to apparatus 200 in connection with FIG. 2.

The one or more user devices 106A-106N and the one or more ATMs 108A-108N may be embodied by any computing devices known in the art. The one or more user devices 106A-106N and the one or more ATMs 108A-108N need not themselves be independent devices, but may be peripheral devices communicatively coupled to other computing devices.

### Example Implementing Apparatuses

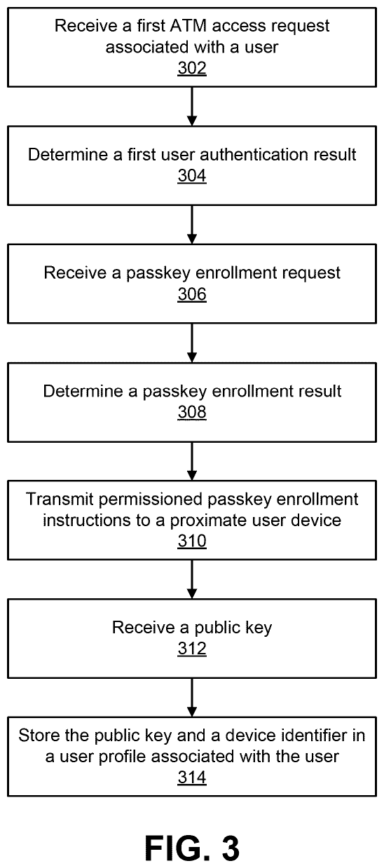

The passkey management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-9. As illustrated in FIG. 2, the apparatus 200 may include processor 202, memory 204, communications hardware 206, user authentication engine 208, and passkey management circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a user authentication engine 208 that determines a passkey enrollment result. In addition, the user authentication engine may generate a passkey authentication challenge. Further, the user authentication engine may determine a passkey authentication result. The user authentication engine 208 may utilize processor 202, memory 204, or any other hardware component included in the apparatus 200 to perform these operations, as described in connection with FIGS. 3-9 below. The user authentication engine 208 may further utilize communications hardware 206 to gather data from a variety of sources (e.g., user device 106A through user device 106N and/or ATM 108A through ATM 108N, as shown in FIG. 1), and/or exchange data with a user, and in some embodiments may utilize processor 202 and/or memory 204.

In addition, the apparatus 200 further comprises a passkey management circuitry 210 that stores the public key and the device identifier in a user profile associated with the user. The passkey management circuitry 210 may utilize processor 202, memory 204, or any other hardware component included in the apparatus 200 to perform these operations, as described in connection with FIG. 3 below. The passkey management circuitry 210 may further utilize communications hardware 206 to gather data from a variety of sources (e.g., user device 106A through user device 106N and/or ATM 108A through ATM 108N, as shown in FIG. 1), and/or exchange data with a user, and in some embodiments may utilize processor 202 and/or memory 204.

Although components 202-210 are described in part using functional language, it will be understood that the particular implementations necessarily include the use of particular hardware. It should also be understood that certain of these components 202-210 may include similar or common hardware. For example, user authentication engine 208 and passkey management circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the user authentication engine 208 and passkey management circuitry 210 may leverage processor 202, memory 204, or communications hardware 206 as described above, it will be understood that any of user authentication engine 208 and passkey management circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that user authentication engine 208 and passkey management circuitry 210 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus, example embodiments are described below in connection with a series of flowcharts.

### Example Operations

Turning to FIGS. 3-9, example flowcharts are illustrated that contain example operations implemented by example embodiments described herein. The operations illustrated in FIGS. 3-9 may, for example, be performed by of the passkey management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, user authentication engine 208, passkey management circuitry 210, and/or any combination thereof. It will be understood that user interaction with the passkey management system 102 may occur directly via communications hardware 206, or may instead be facilitated by a separate computing device (e.g., user device 106A), as shown in FIG. 1, and which may have similar or equivalent physical componentry facilitating such user interaction.

### Example Operations for Automated Teller Machine (ATM) Provisioned Passkey Enrollment

Turning first to FIG. 3, example operations are shown for automated teller machine (ATM) provisioned passkey enrollment.

As shown by operation 302, the apparatus 200 includes means, such as communications hardware 206 or the like, for receiving a first ATM access request associated with a user. The communications hardware 206 may receive a first ATM access request from an ATM in response to a user performing an action with the ATM (e.g., a user login action, such as inputting a PIN, providing a card number, a OTP, a QR code, or any other action that provides an authentication factor to the ATM). In some embodiments, the first ATM access request may be an electronic request to perform an action with respect to a user account via the ATM. The first ATM access request may include a user identifier that uniquely identifies the user that is attempting to access the ATM. An example user identifier may be, but is not limited to a card number, a personal identification number (PIN), a one-time password (OTP), or the like. In addition, the first ATM access request may further include an indication of the ATM (e.g., a location of the ATM, a serial number associated with the ATM, an internet protocol (IP) address associated with the ATM, or the like) that transmitted the first ATM access request to the apparatus 200 (e.g., communications hardware 206).

In some embodiments, the apparatus 200 (e.g., communications hardware 206) may receive the first ATM access request from a computing device (e.g., ATM 108A, ATM 108N, or the like) via a network (e.g., communications network 104, shown in FIG. 1). In some embodiments, upon receiving the first ATM access request, communications hardware 206 may store the first ATM access request in a local storage device (e.g., memory 204, or the like). Additionally or alternatively, upon receiving the ATM access request, communications hardware 206 may immediately provide the first ATM access request to various other components of the apparatus 200 (e.g., user authentication engine 208, or the like) to allow for prompt evaluation of the first ATM access request.

As shown by operation 304, the apparatus 200 includes means, such as memory 204, user authentication engine 208, or the like, for determining a first user authentication result. The first user authentication result may indicate whether a user (e.g., the user associated with the first ATM access request) is authenticated or not authenticated based on a verification of authentication data (e.g., card number, a personal identification number (PIN), a one-time password (OTP), or the like) included in the first ATM access request. For example, the first user authentication result may be a categorical value of “authenticated” or “not authenticated”, a numerical value of 1 for an authenticated user and a numerical value of 0 for a user that is not authenticated, a Boolean value of “true” for an authenticated user or “false” for a non-authenticated user, or the like. In some embodiments, a first user authentication result that corresponds to an authenticated user may indicate that there is a sufficient likelihood that the user associated with the first ATM access request is who they allege they are. Alternatively, a first user authentication result that corresponds to a user that is not authenticated may indicate that there is an insufficient likelihood that the user associated with the first channel authentication response is who they allege they are.

In some embodiments, user authentication engine 208 may use any suitable technique to identify the authentication data and authentication data type (e.g., a PIN code type, a card number type, or the like that identifies a particular kind of authentication factor) included in the first ATM access request. For example, assume that the first ATM access response includes an alphanumeric input. In this regard, user authentication engine 208 may parse the alphanumeric input and compare the parsed input to expected patterns, such as a PIN code pattern, a card number pattern, an OTP pattern, and/or the like. In some embodiments, upon identifying a particular authentication factor included in the first ATM access request, user authentication engine 208 may determine whether the authentication data is associated with a particular account included in an authorized account set. For example, the authorized account set may be a data structure that stores a particular authentication factor (e.g., a PIN) and a user profile and/or user identifier in the form of key-value pairs where the key corresponds to an authentication factor and the value corresponds to the user profile or user identifier that is associated with a particular authentication factor (e.g., PIN 1234 may be a key associated with user profile A for a user A).

In some embodiments, the identified user profile may include baseline authentication data associated with the user to which the user profile corresponds. Baseline authentication data may refer to authentication data that is stored in a user profile and is known to be authentic (e.g., the baseline authentication data may have been obtained during an in-person account setup procedure where the user was authenticated, or at a different time where the user was authenticated). In some embodiments, the baseline authentication factor may be stored in a baseline authentication factor set where each baseline authentication factor and its corresponding authentication factor type are stored in the form of key-value pairs where the key is the baseline authentication factor, and the value is the baseline authentication factor type (or vice versa). In this regard, user authentication engine 208 may utilize the identified baseline authentication factor type (e.g., a PIN code type) to retrieve a corresponding baseline authentication factor of the same authentication factor type as the authentication factor that is included in the first ATM access request.

In some embodiments, user authentication engine 208 may then compare the authentication factor included in the first ATM access request to the retrieved corresponding baseline authentication factor to determine the user authentication result. In some embodiments, user authentication engine 208 may use an authentication factor evaluation set, which may be stored in a local storage device (e.g., memory 204) to determine how to ultimately produce a user authentication result for a particular comparison between a received authentication factor and a corresponding baseline authentication factor. For example, the authentication factor evaluation set may describe that a PIN authentication factor type must exactly match a baseline authentication factor to ultimately determine a successful first user authentication result.

In some embodiments, if the first ATM access request includes multiple authentication factors, each of which corresponding to a different authentication factor type, user authentication engine 208 may utilize the authentication factor evaluation set to determine a partial authentication factor score based for each received authentication factor. For example, the authentication factor evaluation set may describe a particular partial authentication factor score to assign a particular authentication factor based on the amount of character changes that would be required to obtain the baseline authentication factor from the received authentication factor. In some embodiments, user authentication engine 208 may use any suitable method to combine multiple partial authentication scores to generate a total authentication factor score. For example, user authentication engine 208 may calculate a weighted average of partial authentication scores where each partial authentication score for a particular authentication factor is weighted based on a weight that is indicated by the authentication factor evaluation set. Alternatively, user authentication engine 208 may leverage a trained machine learning model to combine each partial authentication score to ultimately determine a total authentication factor score for the first channel authentication response. For example, the machine learning model may be trained using a large training dataset comprising authentic and nonauthentic first ATM access requests, which in turn comprise authentic and nonauthentic authentication factors that correspond to partial authentication scores. As a result, the machine learning model may learn weights for each authentication factor type, and thus may utilize these learned weights to combine the partial authentication scores to form a total authentication score. To this end, user authentication engine 208 may utilize the authentication factor evaluation set to determine whether a particular total authentication score corresponds to a successful first user authentication result (e.g., via a predefined threshold that is defined in the authentication factor evaluation set).

In some embodiments, upon determining a successful first user authentication result, communications hardware 206 may transmit instructions to the ATM (e.g., ATM 108A, or the like) to which the first ATM access request corresponds that instructs the ATM to grant a particular user access to the ATM (e.g., access to perform account-specific operations, such as transactions, withdrawals, balance checks, deposits, device-bound passkey enrollment, or the like).

As shown by operation 306, the apparatus 200 includes means, such as memory 204, communications hardware 206, or the like, for receiving a passkey enrollment request. A passkey enrollment request may be an electronic request that comprises an indicator of a proximate user device (e.g., a user device, such as user device 106A, that is proximate to the ATM that transmitted the first ATM access request) and a user authentication factor associated with the user (e.g., a biometric, a photo of the user, or the like). In some embodiments, the passkey enrollment request may be received from the ATM that the first ATM access request corresponds to (e.g., ATM 108A) in response to a user indicating (e.g., via interaction with the ATM) that the user requests to enroll a computing device associated with the user (e.g., user device 106A, or the like) with a device-bound passkey. Given that a device-bound passkey may provide an individual that is in possession of the device associated with the device-bound passkey access to a user's data, the passkey enrollment request may include additional authentication data that may provide further authentication (in addition to the authentication described above in relation to operation 304) of the user requesting to enroll a computing device with a device-bound passkey. In this regard, the additional authentication data may refer to authentication factors that are less likely to be forged, guessed, or otherwise obtained by a bad actor than a password, PIN, or the like, due to the inherent complexity involved in authentication factor verification. For example, the additional authentication data may refer to biometric data, an indication of an electronic government-issued identifier (e.g., a mobile driver's license (mDL), an image of the user, an image of a government-issued identifier, metadata associated with the passkey enrollment result, or the like).

In some embodiments, the passkey enrollment request may be received by the apparatus 200 (e.g., communications hardware 206) from an ATM (e.g., ATM 108A, or the like) via a network (e.g., communications network 104, shown in FIG. 1). In some embodiments, communications hardware 206 may store the passkey enrollment request in a local storage device, such as memory 204. Additionally or alternatively, communications hardware 206 may provide the passkey enrollment request to user authentication engine 208 to allow the user authentication engine 208 to immediately evaluate the authentication factors included in the passkey enrollment request.

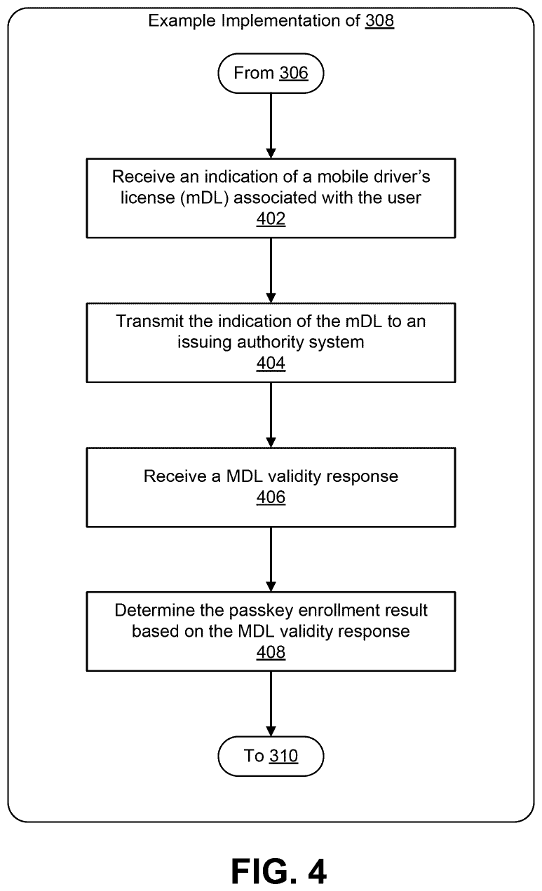

In some embodiments and described further below in relation to operations 308, user authentication engine 208 may determine one or more features from the passkey enrollment request (or from data included in the passkey enrollment request) that may ultimately be used to determine a passkey enrollment result. Turning now to FIGS. 4-6, example operations are shown for determining one or more features from the passkey enrollment request.

Turning now to FIG. 4, example operations are shown for verifying a mobile driver's license (mDL).

As shown by operation 402, the apparatus 200 includes means, such as memory 204, communications hardware 206, or the like, for receiving an indication of a mobile driver's license (mDL) associated with the user. A mDL may refer to various mobile (e.g., digital) identity credential types associated with a respective user including mobile driver's licenses and mobile identification cards. In this regard, an mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system associated with a particular IA. An IA may be an entity that is legally entitled (or otherwise recognized as the relevant authority) to issue credentials such as driver's licenses and/or other identification cards. An IA system may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the passkey management system 102 in compliance with various standards set forth by the American Association of Motor Vehicle Administrators (AAMVA). Additionally, or alternatively, in some embodiments, an mDL may be administered, managed, employed, and/or otherwise utilized by the passkey management system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system and one or more portions of credential data related to the mDL may be retrieved in real time, or near-real time, during a operation e.g., a delegated task) performed by the user. Additionally, or alternatively, once an mDL is issued to a user by a respective IA (e.g., by way of a corresponding IA system), the mDL may be stored locally on a user device associated with the user (e.g., user device 106A) such that the mDL may be used without relying on a communications network (e.g., communications network 104).

In some examples, an IA may provision an mDL to a particular user device (e.g., user device 106A) associated with a user such that the mDL is associated with various user device identification data related to the particular user device (e.g., cryptographical identification data such as a public key). This may ensure that an mDL associated with a respective user cannot be transferred to multiple devices without authorization by the IA system and used in fraudulent transactions. Furthermore, associating an mDL with a particular user device (e.g., user device 106A) also enables the passkey management system 102 and/or an IA system of an IA to verify that the intended user of the mDL is in possession of the mDL. Further still, associating an mDL with a particular user device (e.g., user device 106A) also ensures the safe transfer of sensitive credential data to and/or from the intended user of the mDL.

An mDL may be associated with various mDL data security mechanisms used to ensure the validity of the mDL, authenticate an originating IA that issued the mDL, protect a user's personal data, and/or facilitate secure mDL-based operations (e.g., authentication operations). In this regard, an mDL may be associated with a mobile security object (MSO) and/or various public and private cryptographic key information. An MSO is an electronically managed data structure that enables the authentication of the accuracy and origin of various credential data associated with the mDL during mDL-based operations. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various operations. For example, if the credential data associated with the MSO indicates that the mDL is expired, the corresponding user may not be permitted to engage in one or more operations (e.g., delegated tasks) using the mDL.

In some embodiments, an indication of a mDL may refer to a quick-response (QR) code, such that the QR code includes information associated with the government-issued identifier. In such an embodiment, the indication of a government-issued identifier, such as an QR code associated with a mDL, may point to various credential data associated with the IA that provisioned the mDL and various credential data associated with a respective user.

In some embodiments, the indication of a mDL may be included in the passkey enrollment request. As a result, user authentication engine 208 may extract and store the indication of the mDL in a local storage device (separately than the stored passkey enrollment request) upon receiving the passkey enrollment request.

As shown by operation 404, the apparatus 200 includes means, such as memory 204, communications hardware 206, or the like, for transmitting the indication of the mDL to an issuing authority system associated with an issuing authority that provisioned the mDL. An IA system may be a computing device associated with an issuing authority that provisioned the mDL. In some embodiments, user authentication engine 208 may generate a digital token comprising cryptographic information associated with the mDL. In this regard, the generated token may be transmitted (e.g., by communications hardware 206 and via a network, such as communications network 104) to a corresponding IA system (not shown in FIG. 1). In some embodiments, the generated token may comprise one or more of cryptographical information associated with the mDL, cryptographical information associated with a user device in which the mDL corresponds or was transmitted from, desired credential data associated with the mDL, location data, user profile data, or user account data.

In some embodiments, the indication of the MDL may include an indication of the IA system associated with the IA that provisioned the mDL. As a result, user authentication engine 208 may leverage communications hardware 206 to transmit the digital token associated with the received indication of the mDL to the correct IA. For example, user authentication engine 208 may leverage communications hardware 206 to transmit the digital token to an IA system that provisioned the mDL, such that the IA system may decrypt the cryptographic information comprised in the digital token. In this manner, the IA system may e.g., verify one or more portions of credential data associated with the mDL.

As shown by operation 406, the apparatus 200 includes means, such as memory 204, communications hardware 206, or the like, for receiving a mDL validity response. The mDL validity response may indicate whether the token generated based on the mDL (e.g., the token generated in operation 404) corresponds to verified credential data. In some examples, the mDL validity response may be a categorical value of “verified” or “not verified”, a numerical value of 1 for a verified mDL or 0 for non-verified mDL, a Boolean value of “true” for a verified mDL or “false” for a non-verified mDL, etc.

In some embodiments, communications hardware 206 may receive the mDL validity response from the corresponding IA system (not shown in FIG. 1) that provisioned the mDL via a network (e.g., communications network 104, shown in FIG. 1). Upon receiving the mDL validity response, communications hardware 206 may store the mDL validity response in a local storage device (e.g., memory 204).

As shown by operation 408, the apparatus 200 includes means, such as memory 204, user authentication engine 208, or the like, for determining the passkey enrollment result based on the MDL validity response. As discussed below in relation to operation 308, a passkey enrollment result may indicate whether the user associated with the passkey enrollment request is authorized to enroll a computing device associated with the user with a device-bound passkey. In some embodiments, the MDL validity response may be provided to a machine learning model that may be trained to combine a variety of different input features (e.g., an inferred similarity score, a mDL validity response, a metadata security score, or the like) to ultimately determine a passkey enrollment result. In this regard, user authentication engine 208 may retrieve the MDL validity response from a local storage device (e.g., memory 204) and subsequently provide the MDL validity response to the machine learning model to allow the machine learning model to produce a passkey enrollment result based on the MDL validity response.

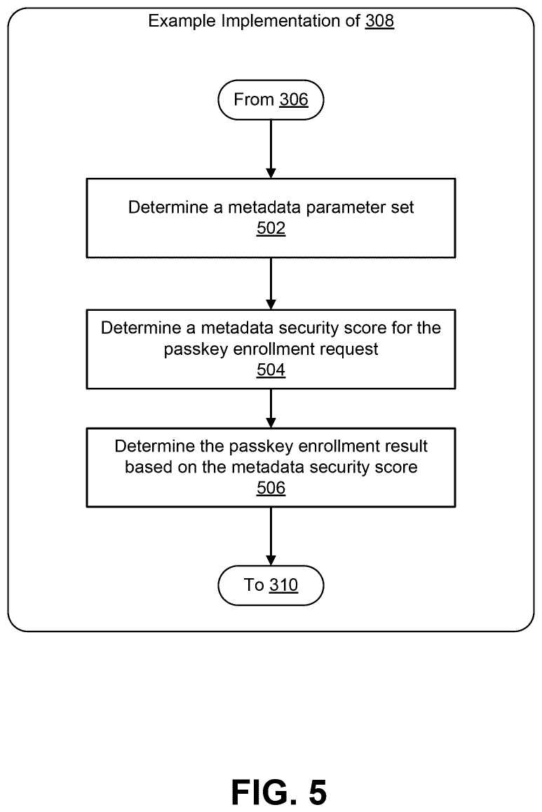

Turning now to FIG. 5, example operations are shown for determining a metadata security score for a passkey enrollment request.

As shown by operation 502, the apparatus 200 includes means, such as memory 204, user authentication engine 208, or the like, for determining a metadata parameter set. The metadata parameters set may include one or more parameters that are based on the metadata associated with the passkey enrollment request. For example, the passkey enrollment request may include metadata indicative of a location of the ATM (e.g., ATM 108A) that transmitted the passkey authentication request, a date/time that the passkey authentication request was generated, or the like. As a result, user authentication engine 208 may utilize a metadata parameter generation set, which may outline particular rules that may be used to evaluate the metadata associated with the passkey enrollment request. For example, the metadata parameter generation set may describe a particular score to assign a particular parameter based on whether the location of the ATM that transmitted the passkey enrollment request is within a predefined radius of a particular location, such as the user's home, or the like. In another example, the metadata parameter generation set may describe a particular score to assign a particular parameter based on the time of day that the response was received.

As a result, user authentication engine 208 may retrieve the passkey enrollment request and metadata parameter set from a local storage device (e.g., memory 204, or the like). Subsequently, user authentication engine 208 may utilize the retrieved passkey enrollment request and metadata parameter generation set to determine a metadata parameter set. Upon generation of the metadata parameter set, user authentication engine 208 may store the user metadata parameter set in a corresponding user profile associated with the user.

As shown by operation 504, the apparatus 200 includes means, such as proc memory 204, user authentication engine 208, or the like, for determining a metadata security score for the passkey enrollment request. The metadata security score may be a numerical score (e.g., a value between 0 and 1) that may indicate a level of security associated with the passkey enrollment request that is based on the metadata associated with the passkey enrollment request. In some embodiments, user authentication engine 208 may leverage a security scoring model to determine a security score for the passkey enrollment request. The security scoring model may be a machine learning model that was trained using a corpus of labeled passkey enrollment requests (e.g., with labeled metadata and a corresponding ground truth outcome, such as an authentic passkey enrollment request and a nonauthentic passkey enrollment request). In this regard, user authentication engine 208 may provide the security scoring model the metadata parameter set to allow the security scoring model to account for each parameter included in the metadata parameter set while generating the metadata security score. Upon the security scoring model generating the metadata security score, user authentication engine 208 may store the generated metadata security score in a user profile associated with the user to which the passkey enrollment request corresponds.

As shown by operation 506, the apparatus 200 includes means, such as memory 204, user authentication engine 208, or the like, for determining the passkey enrollment result based on the metadata security score. As discussed below in relation to operation 308, a passkey enrollment result may indicate whether the user associated with the passkey enrollment request is authorized to enroll a computing device associated with the user with a device-bound passkey. In some embodiments, the metadata security score may be provided to a machine learning model that may be trained to combine a variety of different input features (e.g., an inferred similarity score, a mDL validity response, a metadata security score, or the like) to ultimately determine a passkey enrollment result. In this regard, user authentication engine 208 may retrieve the metadata security score from a local storage device (e.g., memory 204) and subsequently provide the metadata security score to the machine learning model to allow the machine learning model to produce a passkey enrollment result based on the metadata security score.

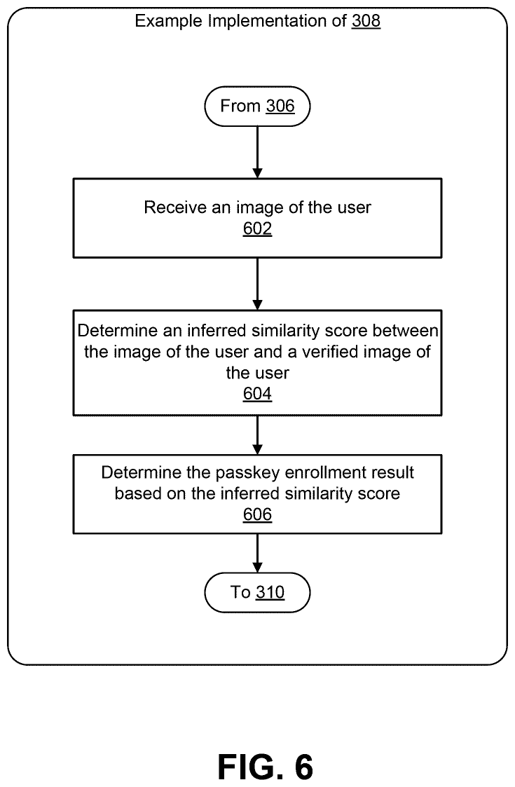

Turning now to FIG. 6, example operations are shown for verifying an image of the user.

As shown by operation 602, the apparatus 200 includes means, such as memory 204, communications hardware 206, or the like, for receiving an image of the user. The image of the user may be an image of the face of the user, such that the apparatus 200 may compare the face of the user interacting with an ATM (e.g., ATM 108A, or the like) to a verified image of the user to initiate a device-bound passkey enrollment procedure. In some embodiments the image of the user may include an ATM indication (e.g., a watermark, metadata, or the like) that indicates that the image was captured by an ATM (e.g., ATM 108A, or the like). In some embodiments, the ATM indication may indicate that the image was captured by the ATM that transmitted the passkey enrollment request to the apparatus 200 (e.g., communications hardware 206). Moreover, the image of the user may be included in the passkey enrollment request. In this regard, the upon receiving the passkey enrollment request, user authentication engine 208 may store a captured image of the user (e.g., captured by the ATM at the time of transmitting the passkey enrollment request to the apparatus 200) in a local storage device (e.g., memory 204).

As shown by operation 604, the apparatus 200 includes means, such as memory 204, user authentication engine 208, or the like, for determining an inferred similarity between the image of the user and a verified image of the user. A verified image of the user may be an image of a face of a user that is known to be a legitimate (e.g., authentic) image of the user. For example, the verified image of the user may be captured during an authenticated session with the user, during an account set up, or the like. In some embodiments, the verified image of the user may be stored in a user profile (e.g., stored in memory 204, or the like) that is associated with the user to which the verified image corresponds.

In some embodiments, user authentication engine 208 may retrieve the image of the user and the verified image of the user from memory 204 to determine an inferred similarity score between the image of the user and a verified image of the user. The inferred similarity score may refer to a numerical score (e.g., a value between 0 and 1), while in other embodiments the inferred similarity score may be converted into a categorical result (e.g., tier 1/tier 2/tier 3, green/yellow/red, or some other categorical classification). For example, a comparison between the image and the verified image may yield a high numerical score (e.g., 0.95), which may indicate that the image and the verified image are similar.

In some embodiments, user authentication engine 208 may leverage a similarity scoring model to determine the inferred similarity score. In some embodiments, the similarity scoring model is a machine learning model that is configured to perform comparisons between a received image and a verified image. In some embodiments, the similarity scoring model is a convolutional neural network (CNN) that may be trained to extract or otherwise determine one or more features from an image of the user and the verified image where the one or more features correspond to a particular feature type (e.g., particular facial landmarks). The features may be encoded into a numerical representation (e.g., a feature vector) that the similarity scoring model may use to determine the similarity between the received image and the verified image. The similarity scoring model may use the one or more features associated with an image of the user and the one or more features associated with the verified image and compare the one or more features of the same feature type. For example, assume the one or more features and corresponding feature types for the image of the user and the government-issued identifier are (i) left eye (120, 150), right eye (250, 150) and (ii) left eye (110, 150), right eye (245, 155). In this regard, the similarity scoring model may generate a partial similarity score based on a comparison between the same feature types (e.g., left eye or right eye). As such, in the above example, the similarity scoring model may generate two partial inferred similarity scores that indicate left eye similarity and right eye similarity respectively. In some embodiments, each partial inferred similarity score may be a numerical score (e.g., a score between 0 and 1), while in other embodiments the partial inferred similarity score may be converted into a categorical result (e.g., tier 1/tier 2/tier3, green/yellow/red, or some other categorical classification).

In some embodiments, the partial inferred similarity score for each feature type may be combined to determine the similarity score. The similarity scoring model may use any suitable method (e.g., calculating an average, calculating a weighted average, or the like) to combine the partial similarity scores to determine the inferred similarity score. For example, the similarity scoring model may assign weights to each partial inferred similarity score based on the corresponding feature type associated with each partial inferred similarity score. For example, a local storage device, such as memory 204, may store a set of partial similarity score rules that describe particular weights associated with each feature type. As such, user authentication engine 208 may provide the set of partial similarity score rules to the similarity scoring model, such that the similarity scoring model may weigh each determined partial inferred similarity score accordingly while determining the inferred similarity score.

Moreover, in some embodiments, the similarity scoring model may utilize any suitable image processing technique, such as noise reduction, or the like, to enhance the image of the user or verified image. In addition, the similarity scoring model may use a segmentation technique to isolate the image of the user and/or the verified image from extraneous features included in the image (e.g., noise). In some embodiments, the inferred similarity score may be stored in a corresponding user profile (e.g., a user profile associated with the user) in a local storage device (e.g., memory 204, or the like).

As shown by operation 606, the apparatus 200 includes means, such as memory 204, user authentication engine 208, or the like, for determining the passkey enrollment result based on the inferred similarity score. As discussed below in relation to operation 308, a passkey enrollment result may indicate whether the user associated with the passkey enrollment request is authorized to enroll a computing device associated with the user with a device-bound passkey. In some embodiments, the inferred similarity score may be provided to a machine learning model that may be trained to combine a variety of different input features (e.g., an inferred similarity score, a mDL validity response, a metadata security score, or the like) to ultimately determine a passkey enrollment result. In this regard, user authentication engine 208 may retrieve the inferred similarity score from a local storage device (e.g., memory 204) and subsequently provide the inferred similarity score to the machine learning model to allow the machine learning model to produce a passkey enrollment result based on the inferred similarity score.

Returning to FIG. 3, as shown by operation 308, the apparatus 200 includes means, such as memory 204, user authentication engine 208, or the like, for determining a passkey enrollment result. The passkey enrollment result may indicate whether the user associated with the passkey enrollment request is authorized to enroll a computing device associated with the user with a device-bound passkey. The passkey enrollment result may be a categorical value of “authorized” or “not authorized”, a numerical value of 1 for an authorized user or 0 for a user that is not authorized, a Boolean value of “true” for an authorized user or “false” for a user that is not authorized, or the like.

In some embodiments, the passkey enrollment result may be based on an evaluation of a variety of different features that are based on data that is included in the passkey enrollment request. For example, the passkey enrollment result may be based on a mDL validity response that indicates the validity of a mDL that is included in the passkey enrollment request (described above in relation to FIG. 4), a security score based on metadata associated with passkey enrollment request (described above in relation to FIG. 5), and an inferred similarity score that indicates the similarity between an image of the user that is included in the passkey enrollment request and a stored image of the user (described above in relation to FIG. 6). To this end, user authentication engine 208 may leverage a machine learning model that may be trained to combine a variety of different input features (e.g., an inferred similarity score, a mDL validity response, a security score, or the like) to ultimately determine a passkey enrollment result. As a result, user authentication engine 208 may provide the variety of different input features to the machine learning model and subsequently store the output classification that is produced by the machine learning model (e.g., authorized or not authorized) in a local storage device (e.g., memory 204, or the like).

As shown by operation 310, the apparatus 200 includes means, such as communications hardware 206, or the like, for transmitting passkey permissioned enrollment instructions to the proximate user device. Permissioned enrollment instructions may be an electronic request that instructs a user device to generate a passkey (e.g., an asymmetric key pair that may be later utilized for passkey authentication challenges where the authenticating entity transmits a challenge to a user device, the user device signs the challenge using a private key, and the signed challenge is verified using the corresponding public key). In some embodiments, the permissioned passkey enrollment instructions are provided to a proximate user device (e.g., user device 106A) in response to the determination of a successful passkey enrollment result (described above in relation to operation 308). In some embodiments, communications hardware 206 may cause an ATM (e.g., ATM 108A) to provide the permissioned passkey enrollment instructions to the proximate user device using near field communication (NFC). In this regard, communications hardware may provide an ATM (e.g., ATM 108A) a provisioning instruction set that causes the ATM to use near field communication (NFC) to transmit the permissioned passkey enrollment instructions to the proximate user device.

As shown by operation 312, the apparatus 200 includes means, such as memory 204, communications hardware 206, or the like, for receiving a public key. A public key may refer to a component of asymmetric cryptography (e.g., public-private key cryptography). A public key is one half of an asymmetric key pair and may be used to in the context of a passkey to ultimately decrypted a signed challenge (e.g., a challenge signed by a corresponding private key securely stored on the proximate user device) for user authentication. In some embodiments, upon the transmission of the permissioned passkey generation request that may cause the user device (e.g., user device 106A, or the like) to generate a public-private key pair, the apparatus 200 (e.g., communications hardware 206) may receive the corresponding public key and an indication of the user and proximate user device (e.g., user device 106A) to which the public key corresponds (e.g., a user ID) from the proximate user device that generated the public-private key pair via a network (e.g., communications network 104, or the like).

As shown by operation 314, the apparatus 200 includes means, such as memory 204, user authentication engine 208, or the like, for storing the public key and the device identifier in a user profile associated with the user. In some embodiments, user authentication engine 208, may store the received public key and received indication of a proximate user device identifier (e.g., a MAC address, IP address, serial number, or the like) in the user profile to which the public key corresponds. As a result, authentication engine 208, or the like, may retrieve a corresponding public key from the user profile in an instance in which the apparatus 200 is required to decrypt a signed challenge that was signed using the corresponding private key (e.g., for passkey authentication).

### Example Operations for Enhanced Automated Teller Machine (ATM) Authentication

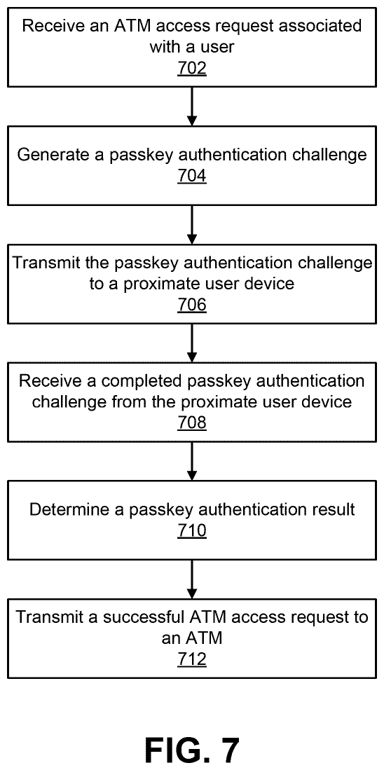

Turning now to FIG. 7, example operations are shown for enhanced ATM authentication.

As shown by operations 702, the apparatus 200 includes means, such as memory 204, communications hardware 206, or the like, for receiving an ATM access request associated with a user. The ATM access request may be an electronic request that is received by the apparatus 200 from an ATM (e.g., ATM 108A, or the like). In some embodiments, the ATM access request may be received in response to a user requesting (e.g., on an ATM or a computing device associated with the user) to access user account data and/or perform account specific actions (e.g., an account balance check, a deposit, a withdrawal, a transfer of funds, and/or the like). The ATM access request may include an indication of a proximate user device (e.g., an indication that is obtained by the ATM via short wave communication, such as NFC, Bluetooth, or the like) that is associated with the user that is requesting access to user account data and/or to perform account specific actions. In some embodiments, the ATM access request may be associated with a particular user, and thus may the ATM access request may include an indication of the user to which the ATM access request corresponds, such as a user identifier, or the like.

In some embodiments, the ATM access request may be received by the apparatus 200 (e.g., communications hardware 206) from an ATM (e.g., ATM 108A, or the like) via a network (e.g., communications network 104, shown in FIG. 1). In some embodiments, communications hardware 206 may store the received ATM access request in a local storage device (e.g., memory 204, or the like). Additionally or alternatively, communications hardware 206 may immediately provide the ATM access request to user authentication engine 208 upon receiving the ATM access request to allow the user authentication engine 208 to immediately generate a passkey authentication challenge for the indicated proximate user device that is included in the ATM access request.

In some embodiments, upon generating a passkey authentication challenge, passkey management circuitry 210 may generate a user authentication log entry. The user authentication log entry may be data that describes a particular ATM access request. For example, the user authentication log entry may record the occurrence of receiving a particular ATM access request associated with a particular user. In this regard, an example user authentication log entry may record that an ATM access request was received and the time at which the ATM access request was received. In some embodiments, the user authentication log entry may be stored in a user authentication log that comprises a user authentication log entry for each ATM access request that is associated with the user. In some embodiments, a user authentication log associated with a user may be utilized to determine whether to generate a passkey authentication challenge for a particular ATM access request (described in further detail below). For example, a user authentication log threshold, which may be predetermined by the entity providing the passkey authentication service provided by passkey management system 102, may be stored in a local storage device, such as memory 204. The user authentication log threshold may describe a predefined frequency of user authentication log entries (e.g., three log entries per hour). To prevent brute force attacks, if the frequency of user authentication log entries in a particular user authentication log is satisfied, passkey management circuitry 210 may deny the user access to the ATM via a passkey. In this regard, the apparatus 200 (e.g., passkey management circuitry 210, or the like) may leverage communications hardware 206 to transmit instructions to a computing device associated with the user or the ATM via a network (e.g., communications network 104, shown in FIG. 1) that reports to the user that they are denied access to the ATM. Alternatively, if the frequency of user authentication log entries does not satisfy the predefined user authentication log threshold, the procedure may advance to operation 704.

As shown by operations 704, the apparatus 200 includes means, such as memory 204, user authentication engine 208, or the like, for generating a passkey authentication challenge. The passkey authentication challenge may be a random string of data (e.g., alphanumeric characters) that expires after a predetermined amount of time (e.g., thirty seconds, one minute, or the like). In some embodiments, user authentication engine 208 may generate a passkey authentication challenge in response to receiving the ATM access request (e.g., received as described above in relation to operation 702). User authentication engine 208 may use any suitable method (e.g., a random bit generator) to generate a randomly generate string (e.g., the passkey authentication challenge). In some embodiments, the passkey authentication challenge may be generated based on a set of passkey generation rules that are determined by the entity that is providing the passkey authentication service provided by passkey management system 102. For example, the passkey generation rules may require user authentication engine 208 to generate a passkey authentication challenge that satisfies a predetermined complexity (e.g., string length) to ensure that the passkey authentication challenge is resistant to brute force attacks. Moreover, the randomness injected into the passkey authentication challenge by utilizing a nonce ensures that each passkey authentication challenge is unique, and thus cannot be reused in future authentication challenges. In some embodiments, the user authentication engine 208 may generate the passkey authentication challenge so that the challenge is associated with a timestamp to enforce a predetermined amount of time (e.g., included in the passkey generation rules) that the passkey authentication challenge is valid (e.g., thirty seconds).

In some embodiments, upon generating the passkey authentication challenge, user authentication engine 208 may store the generated passkey authentication challenge in a local storage device (e.g., memory 204). For example, user authentication engine 208 may store the passkey authentication challenge in a user profile associated with the user that is associated with ATM access request. In some embodiments, user authentication engine 208 may determine a user profile to store the passkey authentication challenge by determining which user to which the passkey authentication challenge corresponds while the user authentication engine 208 generates the passkey authentication challenge. For example, user authentication engine 208 may retrieve the ATM access request from memory 204 and subsequently use any suitable technique (e.g., natural language processing (NLP), or the like) to identify a user identifier included in the ATM access request. Additionally or alternatively, user authentication engine 208 may use any suitable technique to identify a device identifier that is included in the ATM access request and may subsequently determine which user profile of a plurality of user profiles includes the device identifier. Upon determining the user and/or user profile to which the ATM access request corresponds, user authentication engine 208 may store the generated passkey authentication challenge (e.g., a random nonce and expiration time window) in the determined user profile.

As shown by operations 706, the apparatus 200 includes means, such as communications hardware 206, or the like, for transmitting the passkey authentication challenge to the proximate user device. For example, the apparatus 200 (e.g., communications hardware 206) may transmit the passkey authentication challenge to the identified proximate user device (e.g., user device 106A) via a network (e.g., communications network 104, shown in FIG. 1). Alternatively, in some embodiments, communications hardware 206 may transmit instructions and the passkey authentication challenge to the ATM that transmitted the ATM access request (e.g., ATM 108A) that instructs the ATM to transmit the passkey authentication challenge to the proximate user device (e.g., via shortwave technology).

As shown by operations 708, the apparatus 200 includes means, such as memory 204, communications hardware 206, or the like, for receiving a completed passkey authentication challenge. In some embodiments, the completed passkey authentication challenge may refer to a cryptographic proof that may be subsequently used (e.g., in relation to operation 710) to verify that the proximate user device (e.g., user device 106A) is in possession of a private key that corresponds to a public key that is stored in a user profile associated with the user. In this regard, the completed passkey authentication challenge may a transformed version of the passkey authentication challenge that was transformed by using a private key stored on the proximate user device (e.g., user device 106A, or the like).

In some embodiments, the completed passkey authentication challenge may be received by the apparatus 200 (e.g., communications hardware 206) from a proximate user device (e.g., user device 106A, or the like) via a network (e.g., communications network 104, shown in FIG. 1). Upon receiving the completed passkey authentication challenge, communications hardware 206 may store the completed passkey authentication challenge in the user profile to which the generated passkey authentication challenge corresponds. Additionally or alternatively, communications hardware 206 may immediately provide user authentication engine 208 the completed passkey authentication challenge to allow the user authentication engine 208 to immediately determine a passkey authentication result, which is described in further detail below in relation to operation 710.

As shown by operations 710, the apparatus 200 includes means, such as memory 204, user authentication engine 208, or the like, for determining a passkey authentication result. The passkey authentication result may indicate whether a user is authorized to gain access to a user account via an authenticated session with an ATM (e.g., ATM 108A, or the like). In some embodiments, the passkey authentication result may be based on the received completed passkey authentication challenge. For example, user authentication engine 208 may determine whether the corresponding public key that is associated with a user successfully or unsuccessfully transformed the completed passkey authentication challenge into the originally generated passkey authentication challenge. In this regard, user authentication engine 208 may retrieve the public key associated with the user profile to which the passkey authentication challenge corresponds and subsequently utilize the retrieved public key to decrypt the completed authentication challenge. User authentication engine 208 may then compare the decrypted completed passkey authentication challenge to the stored generated passkey authentication challenge to determine whether the decrypted completed passkey authentication challenge and the stored generated passkey authentication challenge match. In addition, user authentication engine 208 may verify that the completed passkey authentication challenge was completed during the expiration time window that was predetermined during the generation of the passkey authentication challenge.

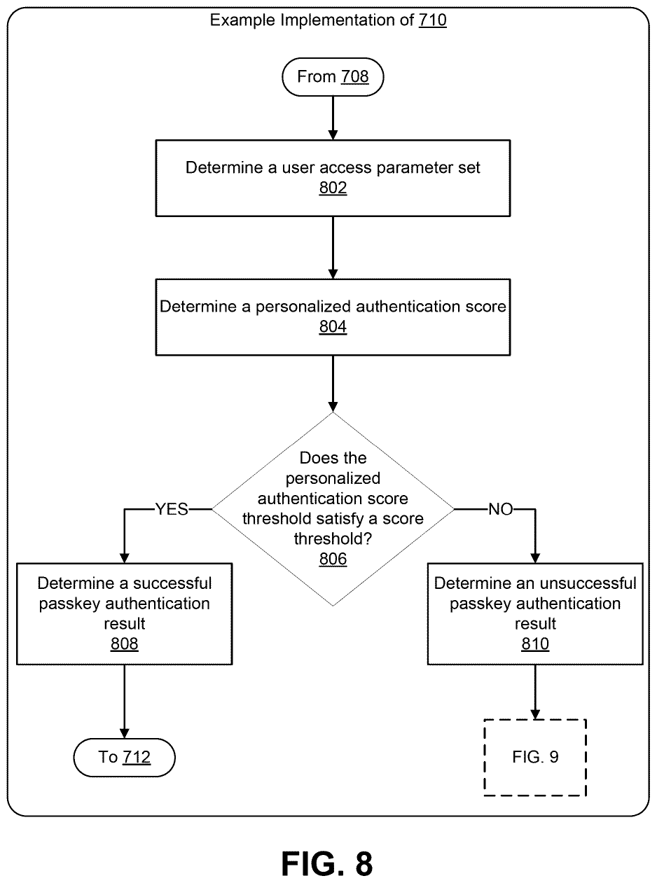

In some embodiments, the passkey authentication result may be further based on a user access parameter set. Turning now to FIG. 8, example operations are shown for determining a passkey authentication result based on a user access parameter set.

As shown by operation 802, the apparatus 200 includes means, such as memory 204, user authentication engine 208, or the like, for determining a user access parameters set. The user access parameter set may refer to a data structure that includes one or more parameters that may be based on various data elements associated with a particular ATM access request. For example, the parameters included in the user access parameter set may be based on metadata associated with the ATM access request. In this regard, user authentication engine 208 may retrieve the ATM access request and a parameter determination set from memory 204 to determine the user access parameter set. The parameter determination set may include a list of rules and/or conditions that particular metadata associated with the ATM access request must satisfy in order to determine a particular parameter included in the user access parameter set. For example, the parameter determination set may describe a particular score to assign a particular parameter based on the location of the ATM associated with the ATM access request, the time/day the ATM access request was received, and/or the like.

To this end, user authentication engine 208 may retrieve the parameter determination set from a local storage device (e.g., memory 204, or the like) and subsequently may utilize the retrieved parameter determination set to determine the user access parameter set. Upon generation of the user access parameter set, user authentication engine 208 may store the user access parameter set in a corresponding user profile associated with the user.

As shown by operations 804, the apparatus 200 includes means, such as memory 204, user authentication engine 208, or the like, for determining a personalized authentication score. The personalized authentication score may be a numerical score (e.g., a value between 0 and 1) that may be used to determine a level of security associated with the ATM access request based on the ATM access requests'metadata. In some embodiments, user authentication engine 208 may leverage a security scoring model to determine a security score for the ATM access request. The security scoring model may be a machine learning model that was trained using a corpus of labeled ATM requests (e.g., with labeled metadata and corresponding ground truth outcomes, such as an authentic ATM access request and a nonauthentic ATM access request. In this regard, user authentication engine 208 may provide the security scoring model the user access parameter set to allow the security scoring model to account for each parameter included in the user access parameters set while determining the personalized authentication score. Upon the security scoring model determining the personalized authentication score, user authentication engine 208 may store the determined personalized authentication score in a user profile associated with the user to which the ATM access request corresponds.

As shown by operations 806, the apparatus 200 includes means, such as memory 204, user authentication engine 208, or the like, for determining whether the personalized authentication score satisfies a personalized authentication score threshold. The personalized authentication score threshold may be predetermined by the entity that is providing the enhanced ATM authentication provided by the apparatus 200. In some embodiments the personalized authentication score threshold may be stored in a local storage device, such as memory 204, or the like. In this regard, user authentication engine 208 may retrieve the personalized authentication score threshold from memory 204 and subsequently compare the personalized authentication score to the retrieved personalized authentication score threshold. In some embodiments, if the personalized authentication score satisfies the personalized authentication score threshold, the procedure may advance to operation 808. Alternatively, if the personalized authentication score does not satisfy the personalized authentication score threshold, the procedure may advance to operation 810.

As shown by operations 808, the apparatus 200 includes means, such as memory 204, user authentication engine 208, or the like for determining a successful passkey authentication result. A successful passkey authentication result may indicate a low security risk associated with the ATM access request. As such, user authentication engine 208 may determine a successful passkey authentication result if the personalized authentication score satisfies the personalized authentication score threshold (and the decrypted completed passkey matches the generated passkey, as discussed above in relation to operation 710). In response to determining a successful passkey authentication result, the procedure may advance to operation 712.

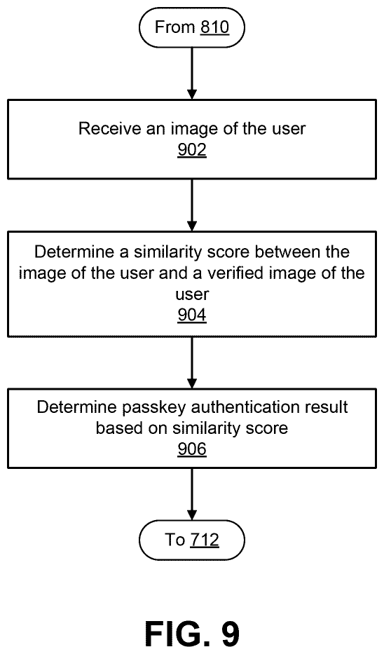

As shown by operations 810, the apparatus 200 includes means, such as processor 202, memory 204, communications hardware 206, or the like, for determining an unsuccessful passkey authentication result. An unsuccessful passkey authentication result may indicate that there is a security risk based on predefined rules that are defined by the entity that is providing the ATM passkey authentication service provided by passkey management system 102. As such, user authentication engine 208 may determine an unsuccessful passkey authentication result if the personalized authentication score does not satisfy the personalized authentication score threshold (and the decrypted completed passkey matches the generated passkey, as discussed above in relation to operation 710). In response to determining an unsuccessful passkey authentication result, the procedure end, and thus deny the user access to the ATM. Alternatively, the procedure may advance to FIG. 9. Turning now to FIG. 9, example operations are shown for verifying an image of the user.

As shown by operations 902, the apparatus 200 includes means, such as memory 204, communications hardware 206, or the like, for receiving an image of the user. The image of the user may be an image of the face of the user, such that the apparatus 200 may compare the face of the user requesting to access data on an ATM (e.g., ATM 108A, or the like) to a verified image of the user. In some embodiments, the image of the user may be captured by and received from the ATM that the user is requesting to access. For example, communications hardware 206 may receive the image of the user from an ATM (e.g., ATM 108A) via a network (e.g., communications network 104, or the like). Upon receiving the image, communications hardware 206 may store the image in a user profile associated with the user to which the ATM access request corresponds.

As shown by operations 904, the apparatus 200 includes means, such as memory 204, user authentication engine 208, or the like, for determining a similarity score between the image of the user and a verified image of the user. A verified image of the user may be an image of a face of a user that is known to be a legitimate image of the user. For example, the verified image of the user may be captured during an authenticated session with the user, during an account set up, or the like. In some embodiments, the verified image of the user may be stored in a user profile (e.g., stored in memory 204, or the like) that is associated with the user to which the verified image corresponds.

In some embodiments, user authentication engine 208 may retrieve the image of the user and the verified image of the user from memory 204 to determine a similarity score between the image of the user and a verified image of the user. The similarity score may refer to a numerical score (e.g., a value between 0 and 1), while in other embodiments the inferred similarity score may be converted into a categorical result (e.g., tier 1/tier 2/tier 3, green/yellow/red, or some other categorical classification). For example, a comparison between the image and the verified image may yield a high numerical score (e.g., 0.95), which may indicate that the image and the verified image are similar.

In some embodiments, user authentication engine 208 may leverage a similarity scoring model to determine the similarity score. In some embodiments, the similarity scoring model is a machine learning model that is configured to perform comparisons between a received image and a verified image. In some embodiments, the similarity scoring model is a convolutional neural network (CNN) that may be trained to extract or otherwise determine one or more features from an image of the user and the verified image where the one or more features correspond to a particular feature type (e.g., particular facial landmarks). The features may be encoded into a numerical representation (e.g., a feature vector) that the similarity scoring model may use to determine the similarity between the received image and the verified image. The similarity scoring model may use the one or more features associated with an image of the user and the one or more features associated with the verified image and compare the one or more features of the same feature type. For example, assume the one or more features and corresponding feature types for the image of the user and the government-issued identifier are (i) left eye (120, 150), right eye (250, 150) and (ii) left eye (110, 150), right eye (245, 155). In this regard, the similarity scoring model may generate a partial similarity score based on a comparison between the same feature types (e.g., left eye or right eye). As such, in the above example, the similarity scoring model may generate two partial similarity scores that indicate left eye similarity and right eye similarity respectively. In some embodiments, each partial similarity score may be a numerical score (e.g., a score between 0 and 1), while in other embodiments the partial similarity score may be converted into a categorical result (e.g., tier 1/tier 2/tier3, green/yellow/red, or some other categorical classification).

In some embodiments, the partial similarity score for each feature type may be combined to determine the similarity score. The similarity scoring model may use any suitable method (e.g., calculating an average, calculating a weighted average, or the like) to combine the partial similarity scores to determine the inferred similarity score. For example, the similarity scoring model may assign weights to each partial inferred similarity score based on the corresponding feature type associated with each partial inferred similarity score. For example, a local storage device, such as memory 204, may store a set of partial similarity score rules that describe particular weights associated with each feature type. As such, user authentication engine 208 may provide the set of partial similarity score rules to the similarity scoring model, such that the similarity scoring model may weigh each determined partial similarity score accordingly while determining the similarity score.

Moreover, in some embodiments, the similarity scoring model may utilize any suitable image processing technique, such as noise reduction, or the like, to enhance the image of the user or verified image. In addition, the similarity scoring model may use a segmentation technique to isolate the image of the user from the received image of the user and/or the verified image. In some embodiments, the similarity score may be stored in a corresponding user profile (e.g., a user profile associated with the user) in a local storage device (e.g., memory 204, or the like).

As shown by operations 906, the apparatus 200 includes means, such as memory 204, user authentication engine 208, or the like, for determining a passkey authentication result based on the similarity score. In some embodiments, user authentication engine 208 retrieve the similarity score from a local storage device (e.g., memory 204) and compare the similarity score to a similarity score threshold that is predefined by the entity that is providing the enhanced ATM authentication provided by the apparatus 200. In this regard if the similarity score satisfies the similarity score threshold, the procedure may advance to operation 712. However, if the similarity score does not satisfy the similarity score threshold, the procedure may end, and thus deny the user access to user account data and/or user account specific actions at the ATM (e.g., ATM 108A).

Returning to FIG. 7, as shown by operations 712, the apparatus 200 includes means, such as communications hardware 206, or the like, for transmitting a successful ATM access request to an ATM (e.g., ATM 108A, or the like). The successful ATM access request may be an electronic request that comprises instructions that instruct the ATM to provide the user access to user account data and/or user account specific actions on the ATM.

FIGS. 3-9 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved user authentication at an ATM. Example embodiments thus provide tools that overcome the problems faced by traditional ATM authentication techniques. By avoiding the need to use a shared secret for authentication, example embodiments increase ATM and user security. Moreover, embodiments described herein avoid security vulnerabilities associated with using a single authentication factor for passkey enrollment and instead rely upon the verification of a myriad of data elements. Finally, by automating functionality that has historically required human analysis, the speed and consistency of the evaluations performed by example embodiments unlocks many potential new functions that have historically not been available, such as the ability to conduct near-real-time dispute resolution.

As these examples all illustrate, example embodiments contemplated herein provide technical solutions that solve real-world problems faced during user authentication with an ATM. And while securely authenticating a user at an ATM has been an issue for decades, the recently exploding amount of data made available by recently emerging technology today has made this problem significantly more acute, as the demand for secure authentication methods has grown significantly even while the complexity of bad actor attacks has itself increased. At the same time, the recently arising ubiquity of passkeys has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for automated teller machine (ATM) provisioned passkey enrollment, the method comprising:
receiving, by communications hardware and from an ATM, a first ATM access request associated with a user, wherein the first ATM access request comprises a user identifier;
determining, by a user authentication engine and based on the user identifier, a first user authentication result;
in response to a successful first user authentication result, receiving, by communications hardware and from the ATM, a passkey enrollment request, wherein the passkey enrollment request comprises a device identifier of a proximate user device and a user authentication factor associated with the user;
determining, by the user authentication engine and based on the passkey enrollment request, a passkey enrollment result;
in response to determining a successful passkey enrollment result, transmitting, by the communications hardware, permissioned passkey enrollment instructions to the proximate user device;
receiving, by the communications hardware and from the proximate user device, a public key; and
storing, by a passkey management circuitry, the public key and the device identifier in a user profile associated with the user.

2. The method of claim 1, further comprising:
receiving, by the communications hardware, an indication of a mobile driver's license (mDL) associated with the user;
transmitting, by the communications hardware, the indication of the mDL to an issuing authority system associated with an issuing authority that provisioned the mDL; and
receiving, by the communications hardware and from the issuing authority system, a mDL validity response, wherein the passkey enrollment result is based on the mDL validity response.

3. The method of claim 1, further comprising:
determining, by the user authentication engine and based on the passkey enrollment request, a metadata parameter set; and
determining, by the user authentication engine, a metadata security score for the passkey enrollment request, wherein the passkey enrollment result is based on the metadata security score.

4. The method of claim 1, further comprising:
receiving, by the communications hardware and from the ATM, an image of the user; and
determining, by the user authentication engine, an inferred similarity score between the image of the user and a verified image of the user, wherein the passkey enrollment result is based on the inferred similarity score.

5. The method of claim 1, further comprising:
providing, by the communications hardware, a provisioning instruction set to the ATM, wherein the provisioning instruction set causes the ATM to use near field communication (NFC) to transmit the permissioned passkey enrollment instructions to the proximate user device.

6. The method of claim 1, further comprising:
receiving, by the communications hardware and from the ATM, an ATM access request, wherein the ATM access request comprises the device identifier;
generating, by the user authentication engine, a passkey authentication challenge;
transmitting, by the communications hardware, the passkey authentication challenge to the proximate user device;
receiving, by the communications hardware and based on the passkey authentication challenge, a completed passkey authentication challenge from the proximate user device;
determining, by the user authentication engine and using the public key, a passkey authentication result; and
in response to a successful passkey authentication result, transmitting, by the communications hardware, a successful ATM access request to the ATM.

7. The method of claim 6, further comprising:
generating, by a passkey management circuitry, a user authentication log entry in a user authentication log that is associated with the user; and
determining, by the passkey management circuitry, whether a frequency of user authentication log entries satisfies a user authentication log threshold, wherein the passkey authentication challenge is generated in response to the frequency not satisfying the user authentication log threshold.

8. The method of claim 6, further comprising:
providing, by the communications hardware, a provisioning instruction set to the ATM, wherein the provisioning instruction set causes the ATM to use near field communication (NFC) to transmit the permissioned passkey enrollment instructions to the proximate user device.

9. An apparatus for automated teller machine (ATM) provisioned passkey enrollment, the apparatus comprising:
communications hardware configured to receive, from an ATM, a first ATM access request associated with a user, wherein the first ATM access request comprises a user identifier;
user authentication engine configured to determine, based on the user identifier, a first user authentication result;
the communications hardware further configured to:
in response to a successful first user authentication result, receive, from the ATM, a passkey enrollment request, wherein the passkey enrollment request comprises a device identifier of a proximate user device and a user authentication factor associated with the user;
the user authentication engine further configured to determine, based on the passkey enrollment request, a passkey enrollment result;
the communications hardware further configured to:
in response to determining a successful passkey enrollment result, transmit permissioned passkey enrollment instructions to the proximate user device; and
receive a public key; and
passkey management circuitry configured to store the public key and the device identifier in a user profile associated with the user.

10. The apparatus of claim 9, wherein the communications hardware is further configured to:
receive an indication of a mobile driver's license (mDL) associated with the user;
transmit the indication of the mDL to an issuing authority system associated with an issuing authority that provisioned the mDL; and
receive, from the issuing authority system, a mDL validity response, wherein the passkey enrollment result is based on the mDL validity response.

11. The apparatus of claim 9, wherein the user authentication engine is further configured to:
determine, based on the passkey enrollment request, a metadata parameter set; and
determine a metadata security score for the passkey enrollment request, wherein the passkey enrollment result is based on the metadata security score.

12. The apparatus of claim 9, wherein the communications hardware is further configured to: receive, from the ATM, an image of the user; and
the user authentication engine is further configured to:
determine an inferred similarity score between the image of the user and a verified image of the user, wherein the passkey enrollment result is based on the inferred similarity score.

13. The apparatus of claim 9, wherein the communications hardware is further configured to provide a provisioning instruction set to the ATM, wherein the provisioning instruction set causes the ATM to use near field communication (NFC) to transmit the permissioned passkey enrollment instructions to the proximate user device.

14. The apparatus of claim 9, where in the communications hardware is further configured to:
receive, from the ATM, an ATM access request, wherein the ATM access request comprises the device identifier;
the user authentication engine further configured to:
generate a passkey authentication challenge;
the communications hardware further configured to:
transmit the passkey authentication challenge to the proximate user device, and
receive, based on the passkey authentication challenge, a completed passkey authentication challenge from the proximate user device;
the user authentication engine further configured to:
determine, using the public key, a passkey authentication result; and
the communications hardware further configured to:
in response in response to a successful passkey authentication result, transmit a successful ATM access request to the ATM.

15. The apparatus of claim 14, wherein the passkey management circuitry is further configured to:
generate a user authentication log entry in a user authentication log that is associated with the user; and
determine whether a frequency of user authentication log entries satisfies a user authentication log threshold, wherein the passkey authentication challenge is generated in response to the frequency not satisfying the user authentication log threshold.

16. A computer program product for automated teller machine (ATM) provisioned passkey enrollment, the computer program product comprising a non-transitory computer-readable storage medium storing instructions that, when executed by an apparatus, cause the apparatus to:
receive, from an ATM, a first ATM access request associated with a user, wherein the first ATM access request comprises a user identifier;
determine, based on the user identifier, a first user authentication result;
in response to a successful first user authentication result, receive, from the ATM, a passkey enrollment request, wherein the passkey enrollment request comprises a device identifier of a proximate user device and a user authentication factor associated with the user;
determine, based on the passkey enrollment request, a passkey enrollment result;
in response to determining a successful passkey enrollment result, transmit permissioned passkey enrollment instructions to the proximate user device;
receive a public key; and
store the public key and the device identifier in a user profile associated with the user.

17. The computer program product of claim 16, wherein the instructions, when executed by the apparatus, further cause the apparatus to:
receive an indication of a mobile driver's license (mDL) associated with the user;
transmit the indication of the mDL to an issuing authority system associated with an issuing authority that provisioned the mDL; and
receive, from the issuing authority system, a mDL validity response, wherein the passkey enrollment result is based on the mDL validity response.

18. The computer program product of claim 16, wherein the instructions, when executed by the apparatus, further cause the apparatus to:
determine, based on the passkey enrollment request, a metadata parameter set; and
determine a metadata security score for the passkey enrollment request, wherein the passkey enrollment result is based on the metadata security score.

19. The computer program product of claim 16, wherein the instructions, when executed by the apparatus, further cause the apparatus to:
receive, from the ATM, an image of the user; and
determine an inferred similarity score between the image of the user and a verified image of the user, wherein the passkey enrollment result is based on the inferred similarity score.

20. The computer program product of claim 16, wherein the instructions, when executed by the apparatus, further cause the apparatus to:
provide a provisioning instruction set to the ATM, wherein the provisioning instruction set causes the ATM to use near field communication (NFC) to transmit the permissioned passkey enrollment instructions to the proximate user device.

21-40. (canceled)
